(19) United States
(12) Patent Application Publication
(10) Pub. No.: US 2026/0053141 A1
(43) Pub. Date: Feb. 26, 2026

(54) AGROCHEMICAL FORMULATION

(71) Applicant: SYNGENTA CROP PROTECTION AG, Basel (CH)

(72) Inventor: Charles JONES, Greensboro, NC (US)

(73) Assignee: SYNGENTA CROP PROTECTION AG, Basel (CH)

(21) Appl. No.: 19/105,598

(22) PCT Filed: Aug. 29, 2023
(86) PCT No.: PCT/EP2023/073708

§ 371 Date: Feb. 21, 2025

(30) Foreign Application Priority Data
Aug. 31, 2022 (EP) 22193091.0

(51) Int. Cl. A01N 43/80; A01N 25/04; A01N 37/22; A01P 3/00

(52) U.S. Cl. CPC A01N 43/80; A01N 25/04; A01N 37/22; A01P 3/00

(57) ABSTRACT

The present invention relates to compositions comprising oxathiapiprolin, metalaxyl-M, at least one component selected from a surfactant, an emulsifier, and a dispersing agent; and a solvent system, including a water-soluble solvent, a first partially water-soluble solvent, and a second partially water-soluble solvent.

### TECHNICAL FIELD

This disclosure relates to agrochemical compositions, preferably dispersible concentrates (DC), and dilutions or dispersions of such compositions. More particularly, in a farmer's spray-tank; and to the use of such a composition in agriculture or horticulture for controlling or preventing infestation of plants by pests, such as phytopathogenic microorganisms, preferably fungi.

### BACKGROUND

By 2050, the global population is expected to reach 9.7 billion people. Such an increase would require a 60% increase in food production compared with 2005-2007 levels. To this end, agrochemical compositions are used to facilitate the growth, health, and storage of crops thereby improving yields.

In order to maximize efficiency, it is often preferable to combine multiple agrochemicals into a single composition. Indeed, single compositions may offer efficiency for storage, transportation, or application in addition to resistance management in target pests. However, combining multiple agrochemicals into a single composition often results in complex interactions between each agrochemical which effects the stability and application of the single composition.

Moreover, one particular challenge with DC type formulations is effective dispersion upon dilution. When a DC is diluted for application, if the particle size of the precipitated agrochemical is too large, the equipment used for application of the DC can be clogged. Not only does clogging risk damage and destruction of application equipment but can also slow the application process which may put crops at risk.

Accordingly, there is a need for new agrochemical compositions.

### SUMMARY

The disclosure relates to compositions having, oxathiapiprolin, metalaxyl-M, at least one component selected from a surfactant, an emulsifier, and a dispersing agent; and a solvent system, including a water-soluble solvent, a first partially water-soluble solvent, and a second partially water-soluble solvent.

Alternatively, the disclosure relates to compositions, having a first agrochemical, a second agrochemical, at least one component selected from a surfactant, an emulsifier, and a dispersing agent, and a solvent system, that dissolves the first and second agrochemical, having a water-soluble solvent, and a partially water-soluble solvent, wherein the composition is a dispersible concentrate, and wherein the first agrochemical is different from the second agrochemical.

Other embodiments relate to a composition, having a first agrochemical, at least one component selected from a surfactant, an emulsifier, and a dispersing agent, and a solvent system, that dissolves the first agrochemical, including: a water-soluble solvent, a first partially water-soluble solvent, and a second partially water-soluble solvent, wherein the composition is a dispersible concentrate, and wherein the first agrochemical is different from the second agrochemical.

The disclosure further relates to methods of use of such compositions.

### BRIEF DESCRIPTION OF DRAWINGS

FIG. 1A shows Composition A (comparative composition) made up in 500 ppm water at various tank turnovers.

FIG. 1B shows Composition A made up in 500 ppm water at various tank turnovers after being static overnight.

FIG. 2 shows residue build-up on a mesh in-line filter after spray-out using Composition A.

FIG. 3 shows cumulative build-up of sandy material in spray tank after subsequent loads using Composition A.

FIG. 4A shows a micrograph (40×) of Composition A at 4.5%.

FIG. 4B shows a micrograph (40×) of Composition A at 4.5% after 18 turnovers.

FIG. 5 shows images of 50 and 100 mesh in-line filters and nozzles screens after spray-out using Composition 1 (according to the present invention).

FIG. 6 shows images of a spray tank after 4 loads of using Composition 1.

### DETAILED DESCRIPTION

Before certain embodiments are described in greater detail, it is to be understood that this disclosure is not limited to embodiments described, as such may, of course, vary. It is also to be understood that the terminology used herein is for the purpose of describing certain embodiments only, and is not intended to be limiting, since the scope of the present disclosure will be limited only by the appended claims.

Described herein are several definitions. Such definitions are meant to encompass grammatical equivalents.

The use of “or” means “and/or” unless stated otherwise. Furthermore, the use of the terms “comprising,” “having,” “including,” as well as other forms, such as “includes” and “included,” are intended to be inclusive and mean that there may be additional elements other than the listed elements.

As used herein, the term “about” when referring to a measurable value such as an amount, a temporal duration, and the like, is meant to encompass variations. Such variations, however, are dependent on the specific component referred to and the context as understood by a person of ordinary skill in the art.

As used herein, the term “dispersible concentrate” (abbreviation DC) refers to a liquid homogeneous preparation to be applied as a solid dispersion after dilution with water.

As used herein, the term “dispersion” refers to a system comprising more than one phases or more than one component (chemical individuals), whereby one phase or component is dispersed in the second phase or component. A dispersion is a system in which distributed particles of one material are dispersed in a continuous phase of another material. The two phases may be in the same or different states of matter.

As used herein the term “agrochemical” refers to chemicals, such as those described herein, like oxathiapiprolin and metalaxyl-M, both being fungicides. Herein the term “agrochemical” can be used interchangeably with “agrochemical active ingredient” or “agrochemical ingredient”.

As used herein, the term “partially water-soluble” refers to a solvent which dissolves in water to make a solution (usually expressed as grams of solvent per liter of water), wherein said solvent has a solubility in water of 0.01 to 10% w/w, preferably 0.01 to 5% w/w, more preferably 0.01 to 1% w/w, at a temperature of 20 to 25° C. Examples of partially water-soluble solvents are aromatic ketones, like benzophenone (diphenylmethanon, water solubility 0.23 g/L (0.03% w/w) at 25° C.), acetophenone (1-phenylethanon, water solubility 6.9 g/L (0.69% w/w) water at 25° C.), or propiophenone (1-phenylpropan-1-on, water solubility 2 g/L (0.2% w/w) at 20° C.); or an ester-derivative of lactic acid (also referred to as partially water-soluble solvent lactic acid derivative, or “the partially water-soluble solvent is a lactic acid derivative”), for example 2-ethylhexyl-lactate, or 2-ethylhexyl-S-lactate ((2S)-2-Ethylhexyl 2-hydroxypropanoate, CAS-RN 186817-80-1, water solubility 0.43 g/L at 20° C., 0.04% w/w).

As used herein, the term “water-soluble” refers to a solvent which dissolves in water to make a solution at a temperature of 20° C. to 25° C. at any ratio without phase separation.

As used herein, the term “hydroxyl” or “hydroxy” means an —OH group.

As used herein, the term “C₁₋ₙalkyl” refers to a straight or branched hydrocarbon chain radical consisting solely of carbon and hydrogen atoms, containing no unsaturation, having from one to n carbon atoms, and which is attached to the rest of the molecule by a single bond. C₁₋₃alkyl should be construed accordingly. Examples of C₁₋ₙalkyl include, but are not limited to, methyl, ethyl, iso-propyl.

As used herein, the term “C₂₋ₙalkenyl” refers to a straight or branched hydrocarbon chain radical group consisting solely of carbon and hydrogen atoms, containing at least one double bond that may be of either the (E) or (Z) configuration, having two or n carbon atoms, which is attached to the rest of the molecule by a single bond. Examples of C₂₋ₙalkenyl include, but are not limited to, vinyl(ethenyl), prop-1-enyl, allyl(prop-2-enyl).

As used herein, the term “C₂₋ₙalkynyl” refers to a straight or branched hydrocarbon chain radical group consisting solely of carbon and hydrogen atoms, containing at least one triple bond, having from two or n carbon atoms, and which is attached to the rest of the molecule by a single bond. Examples of C₂₋ₙalkynyl include, but are not limited to, prop-1-ynyl and propargyl(prop-2-ynyl).

As used herein, the term “C₃₋₆cycloalkyl” refers to a stable, monocyclic ring radical which is saturated and contains 3 or 6 carbon atoms. Examples of C₃₋₆cycloalkyl include, but are not limited to cyclopropyl, cyclobutyl, or cyclopentyl.

As used herein, the term “C₁₋ₙalkoxy” refers to a radical of the formula RₐO— where Rₐ is a C₁₋₃alkyl radical as generally defined above. Examples of C₁₋₃alkoxy include, but are not limited to, methoxy, ethoxy, iso-propoxy

As used herein, the term “optionally substituted”, means that the group referenced is either unsubstituted or is substituted by a designated substituent, for example, “C₃-C₄cycloalkyl is optionally substituted with 1 or 2 halo atoms” means C₃-C₄cycloalkyl, C₃-C₄cycloalkyl substituted with 1 halo atom and C₃-C₄cycloalkyl substituted with 2 halo atoms. Further the term “optionally substituted” as used herein, means that the referred group is unsubstituted or substituted. The term “optionally substituted” can be used interchangeably with “unsubstituted or substituted”.

The term “optionally in the presence of” as used herein means, that a certain process is carried out in the presence or in the absence of the reagent referenced, for example “the process is carried out optionally in the presence of a base” means the process can be carried out with a base or without a base.

As used herein, the term “controlling” refers to reducing the number of pests, eliminating pests and/or preventing further pest damage such that damage to a plant or to a plant derived product is reduced.

As used herein, the term “pest” refers to insects, and molluscs that are found in agriculture, horticulture, forestry, the storage of products of vegetable origin (such as fruit, grain, and timber); and those pests associated with the damage of man-made structures. The term pest encompasses all stages in the life cycle of the pest.

As used herein, the term “effective amount” refers to the amount of the compound, or a salt thereof, which, upon single or multiple applications provides the desired effect.

An effective amount is readily determined by the skilled person in the art, using known techniques and by observing results obtained under analogous circumstances. In determining the effective amount, a number of factors are considered including, but not limited to the type of plant or derived product to be applied; the pest to be controlled & its lifecycle; the particular compound applied; the type of application; and other relevant circumstances.

As used herein, the term “room temperature” or “RT” or “rt” refer to a temperature of about 15° C. to about 35° C. For example, rt can refer to a temperature of about 20° C. to about 30° C.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, representative illustrative methods, and materials are now described.

Each of the individual embodiments described and illustrated herein has discrete components and features which may be readily separated from or combined with the features of any of the other several embodiments without departing from the scope or spirit of the present disclosure. Any recited method can be carried out in the order of events recited or in any other order which is logically possible.

Unless indicated otherwise, percentages of a component in the composition refers to w/w (based on the total weight of the composition).

One example of a challenging single agrochemical composition having multiple agrochemicals, is illustrated with the Composition A (comparative composition described in Table 1 below). Composition A is a dispersible concentrate (DC) of oxathiapiprolin and metalaxyl-M. While Composition A was generally effective, performance issues were noticed when applied in-furrow at label use rates suitable for potatoes in water that is aggressive (cold, hard, high alkalinity/bicarbonate or combinations thereof). During application, oxathiapiprolin crystals formed in the spray solution but subsequently flocculated to create hard packed sandy residues that built-up on in-line filters, spray nozzle, and tanks.

Compositions disclosed herein can also impart improved spray application performance in water that is cold/hard/highly alkaline (or combinations thereof) at higher use rates and lower spray volumes required for crops such as potatoes without sacrificing performance at lower use rates and/or higher spray volumes required for other crops like tobacco.

### Compositions

The compositions described herein are preferably dispersible concentrate (DC) formulations. A DC is a liquid formulation that is applied as a solid dispersion after dilution in water. In general, a DC contains a water miscible organic solvent, or a mixture of multiple solvents, for dissolving a water-insoluble or partially soluble agrochemical. When the DC is diluted in water, the agrochemical precipitates out and disperses as solid particles. The solvent is dissolved in water. DCs can contain surfactants/emulsifiers (etc) that assist in the application of the precipitated solid particles. In some embodiments, the DC can also include water so long as the amount does not affect the stability of the overall composition; however, DCs are preferably formulated without water. Other ingredients can also be included, such as, compatibility agents, stickers, film formers, slip agents, colorants, etc.

### Agrochemicals

The term “agrochemical” or equivalent terms include compounds or ingredients registered as being biologically active against an agricultural pest. In general, agrochemical active ingredients include compounds listed in: The Pesticide Manual, 12th edition, 2001, British Crop Protection Council. Agrochemicals include, but are not limited to herbicides, fungicides, other insecticides, bactericides, insect growth regulators, plant growth regulators, nematicides, molluscicides or mixtures of several of these preparations.

The term “agrochemically effective” or equivalent terms generally refer to approved rates of application of an agrochemical. An agrochemically effective amount is generally determined by the specific crop and agrochemical being used.

The total amount of each agrochemical, or total amount of agrochemical in the composition, is generally in the range of from 1 to 40% w/w, preferably from 1 to 30% w/w, and most preferably 5 to 20% w/w, based on the total weight of the composition.

In general, compositions described herein comprise two different agrochemicals. In the context of DCs, both agrochemicals can be dissolved in the composition. However, additional agrochemicals in different states can be included in the composition.

Preferred agrochemical ingredients (or agrochemicals) include oxathiapiprolin and metalaxyl-M, both being fungicides.

Oxathiapiprolin is a fungicide with the following CAS number: 1003318-67-9, and has the following chemical formula:

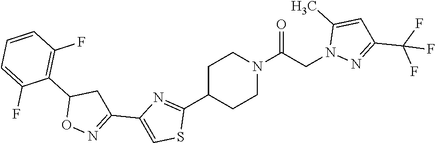 [SMILES: Cc1cc(C(F)(F)F)nn1CC(=O)N1CCC(c2nc(C3=NOC(c4c(F)cccc4F)C3)cs2)CC1]

The mechanism of action for oxathiapiprolin involves binding to the oxysterol-binding protein in Oomycetes.

In one embodiment of the invention, the composition comprises 1 to 20% w/w of oxathiapiprolin, preferably 1 to 10% w/w, and more preferably 1 to 5% w/w, based on the total weight of the composition.

In a preferred embodiment of the invention, the composition comprises 1 to 5% w/w of oxathiapiprolin, based on the total weight of the composition.

Metalaxyl-M is a fungicide with the following CAS number: 70630-17-0, also known under the name of mefenoxam, and has the following chemical formula:

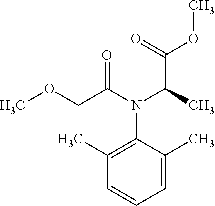

In one embodiment of the invention, the composition comprises 1 to 30% w/w of metalaxyl-M, preferably 5 to 30% w/w, more preferably 5 to 25% w/w, and most preferably 5 to 15% w/w, based on the total weight of the composition.

In a preferred embodiment of the invention, the composition comprises 5 to 15% w/w of metalaxyl-M, based on the total weight of the composition.

In another preferred embodiment of the invention, the composition comprises 1 to 5% w/w of oxathiapiprolin, and 5 to 15% w/w of metalaxyl-M, based on the total weight of the composition.

### Solvent Systems

In general, the solvent systems used in the compositions are configured to dissolve at least one agrochemical in the composition. The solvent system is generally composed of at least one water-soluble solvent and at least one partially water-soluble solvent. In preferred embodiments, the solvent system contains a water-soluble and two partially water-soluble solvents. The total amount of solvent present in the composition is 40 to 80% w/w, preferably 50 to 70% w/w, and most preferably 55 to 65% w/w.

As used herein, water-soluble solvents have a solubility of at least 10% w/w, preferably 50% w/w, and most preferably 100% w/w (completely miscible). The water-soluble solvent is present in the composition at 10 to 40% w/w, preferably 10 to 30% w/w, and most preferably 15 to 25% w/w.

As used herein, partially water-soluble solvents have a solubility of 0.01 to 10% w/w, preferably 0.01 to 5% w/w, and most preferably 0.1 to 1% w/w. The total amount of partially water-soluble solvent can be 10 to 50% w/w, preferably 10 to 40% w/w, and most preferably 15 to 35% w/w. In embodiments where more than one partially water-soluble solvent is present, the each partially water-soluble solvent can be present at 5 to 25% w/w, preferably 5 to 20% w/w, and most preferably 10 to 20% w/w. Some embodiments can be defined by various ratios of partially water-soluble solvents, such as: 1:9 to 9:1, preferably 1:4 to 4:1, and most preferably 1:3 to 3:1. Similarly, embodiments can be described by the ratio of water-soluble solvent to partially water-soluble solvent, these can be 1:9 to 9:1, preferably 1:5 to 5:1, and most preferably 1:3 to 3:1.

In one embodiment of the invention, the partially water-soluble solvent has a solubility in water at 20° C. to 25° C. of 0.01 to 10% w/w, preferably 0.01 to 5% w/w, and more preferably 0.01 to 1% w/w.

Examples of water-soluble solvents include, but are not limited to: Dipropylene glycol monomethyl ether (CAS Number: 34590-4-8) (Dowanol® DPM); Ethyl lactate, Ethyl 2-hydroxypropanoate, (CAS Numbers: 687-47-8, 97-64-3, 7699-00-5) (Purasolv® EL); n-Propyl-L-Lactate, (CAS Number: 53651-69-7) (Purasolv® NPL); Methyl L-lactate, (CAS Number: 27871-49-4) (Purasolv® ML); N-methyl pyrrolidinone, 1-Methylpyrrolidin-2-one, (CAS Number: 872-50-4); Propylene Carbonate, 4-Methyl-1,3-dioxolan-2-one (CAS Number: 108-32-7); N,N-dimethyl lactamide (2-Hydroxy-N,N-dimethylpropanamide, or dimethyl lactamide, CAS-RN: 35123-06-9, commercially available as Agnique© AMD 3 L from BASF), and Tetrahydrofurfuryl alcohol, (Oxolan-2-yl)methanol, (CAS Number: 97-99-4).

In one embodiment, the water-soluble solvent is an ester-amide derivative of lactic acid (also referred to as water-soluble solvent lactic acid derivative), preferably N,N-dimethyl lactamide (2-Hydroxy-N,N-dimethylpropanamide, or dimethyl lactamide, CAS-RN: 35123-06-9, commercially available as Agnique® AMD 3 L from BASF). N,N-dimethyl lactamide can be regarded as a safe, protic, water-soluble solvent.

The ester-amide derivative of lactic acid (also referred to as water-soluble solvent lactic acid derivative) is a lactamide compound of formula (I)

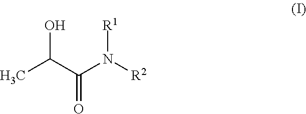

wherein
R¹ and R² are each independently selected from hydrogen, C₁₋₆ alkyl, C₂₋₆ alkenyl, or C₃₋₆ cycloalkyl, each of which is unsubstituted or substituted by up to three substituents independently selected from phenyl, hydroxy, C₁₋₅ alkoxy, morpholinyl, or NR³R⁴, wherein R³ and R⁴ are each independently selected from C₁₋₃ alkyl; or phenyl, wherein said phenyl is unsubstituted or substituted by up to three substituents independently selected from C₁₋₃ alkyl; or
R¹ and R² together with the nitrogen atom to which they are attached form a morpholinyl, pyrrolidinyl, piperidinyl, or azepanyl ring, each of which is unsubstituted or substituted by up to three substituents independently selected from C₁₋₃ alkyl.

In one embodiment in the lactamide compound of formula (I)

R¹ and R² are each independently selected from C₁₋₃ alkyl.

Preferably in the lactamide compound of formula (I) R¹ and R² are each independently selected from methyl, ethyl, or propyl. More preferably in the lactamide compound of formula (I) R¹ and R² are methyl.

Examples of partially water-soluble solvents include, but not limited to: benzyl acetate (CAS-RN: 140-11-4, water solubility 3 g/L at 25° C., 0.3% w/w); butyl acetate and isomers (0.6-0.8% w/w, water solubility of n-butyl acetate 6.8 g/L at 20° C., 0.7% w/w), n-butyl L-lactate (CAS-RN: 34451-19-9, commercially available as Purasolv® BL, water solubility 42 g/L at 25° C., 4.2% w/w); mixture of N, N-dimethyloctanamide and N, N dimethyldecanamide (CAS-RN: 1118-92-9, commercially available as HALLCOMID® M-8-10, water solubility 0.12%); cyclohexanone (CAS-RN: 108-94-1, water solubility at 25° C. 103 g/L, 10.3% w/w); benzophenone (CAS-RN: 119-61-9, diphenylmethanon, water solubility 0.23 g/L (0.03% w/w) at 25° C.), acetophenone (CAS-RN: 98-86-2,1-phenylethanon, water solubility 6.9 g/L (0.69% w/w) water at 25° C.), propiophenone (CAS-RN: 93-55-0,1-phenylpropan-1-on, water solubility 2 g/L (0.2% w/w) at 20° C.)., and Isophorone (3,5,5-trimethylcyclohex-2-en-1-one, CAS Number: 78-59-1, water solubility at 25° C. 1.2 g/L, 1.2% w/w).

In one embodiment of the invention, the partially water-soluble solvent is an aromatic ketone, selected from benzophenone (diphenylmethanon, water solubility 0.23 g/L (0.03% w/w) at 25° C.), acetophenone (1-phenylethanon, water solubility 6.9 g/L (0.69% w/w) water at 25° C.), or propiophenone (1-phenylpropan-1-on, water solubility 2 g/L (0.2% w/w) at 20° C.). Preferably, the partially water-soluble solvent is acetophenone.

In one embodiment of the invention, the partially water-soluble solvent is an ester of lactic acid of formula (11)

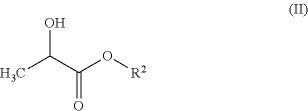

wherein R¹ is selected from C₄-C₁₀alkyl, wherein said C₄-C₁₀alkyl is unsubstituted or substituted by one or two substituents selected from C₁-C₃alkyl.

Preferably in the compound of formula (II) R¹ is selected from C₆-C₈alkyl, wherein said C₆-C₈alkyl is unsubstituted or substituted by one or two substituents selected from methyl, ethyl or isopropyl.

More preferably in the compound of formula (II) R¹ is selected from C₆alkyl, wherein said C₆alkyl is unsubstituted or substituted by one or two substituents selected from methyl, or ethyl.

In another embodiment of the invention, the partially water-soluble solvent is an ester of lactic acid (also referred to as partially water-soluble solvent lactic acid derivative), preferably a branched C₆₋₁₀alkyl ester of lactic acid, more preferably 2-ethylhexyl-lactate, and most preferably 2-ethylhexyl-S-lactate ((2S)-2-Ethylhexyl 2-hydroxypropanoate, CAS-RN 186817-80-1).

In another embodiment, the partially water-soluble solvent is an ester derivative of lactic acid (also referred to as partially water-soluble solvent lactic acid derivative or lactic acid ester-derivative), preferably 2-ethylhexyl-lactate, most preferably 2-ethylhexyl-(S)-lactate.

Preferred embodiments are directed to compositions having two partially water-soluble solvents. These can be a combination of an aromatic ketone (such as acetophenone) and a lactic acid ester-derivative (such as 2-ethylhexyl-S-lactate).

In another embodiment, the composition of the present invention comprises a first partially water-soluble solvent and second partially water-soluble solvents, wherein said first partially water-soluble solvent is different than said second partially water-soluble solvent. In one embodiment, the first partially water-soluble solvent is selected from an aromatic ketone, preferably benzophenone, propiophenone or acetophenone, more preferably acetophenone. In one embodiment, the second partially water-soluble solvent is selected from an ester of lactic acid (also referred to as partially water-soluble lactic acid derivative or ester-derivative of lactic acid), preferably 2-ethylhexyl-lactate, and more preferably 2-ethylhexyl-(S)-lactate ((2S)-2-Ethylhexyl 2-hydroxypropanoate, CAS-RN 186817-80-1).

In one embodiment of the invention, a composition comprising a first agrochemical;
a second agrochemical;
at least one component selected from a surfactant, an emulsifier, and a dispersing agent; and
a solvent system, that dissolves said first and second agrochemical, comprising:
a water-soluble solvent, and
a partially water-soluble;
wherein the composition is a dispersible concentrate; and
wherein said partially water-soluble solvent has a solubility in water at 20° C. to 25° C. of 0.01 to 10% w/w.

In a preferred embodiment of the invention, a composition comprising a first agrochemical;
a second agrochemical;
at least one component selected from a surfactant, an emulsifier, and a dispersing agent; and
a solvent system, that dissolves said first and second agrochemical, comprising:
a water-soluble solvent, and
a partially water-soluble;
wherein the composition is a dispersible concentrate; and
wherein said partially water-soluble solvent has a solubility in water at 20° C. to 25° C. of 0.01 to 5% w/w.

In a more preferred embodiment of the invention, a composition comprising a first agrochemical;
a second agrochemical;
at least one component selected from a surfactant, an emulsifier, and a dispersing agent; and
a solvent system, that dissolves said first and second agrochemical, comprising:
a water-soluble solvent, and
a partially water-soluble;
wherein the composition is a dispersible concentrate; and
wherein said partially water-soluble solvent has a solubility in water at 20° C. to 25° C. of 0.01 to 1% w/w.

In one embodiment of the invention, a composition comprising a first agrochemical, wherein said first agrochemical is oxathiapiprolin;
a second agrochemical, wherein said second agrochemical is metalaxyl-M;
at least one component selected from a surfactant, an emulsifier, and a dispersing agent; and
a solvent system, that dissolves said first and second agrochemical, comprising:
a water-soluble solvent, and
a partially water-soluble;
wherein the composition is a dispersible concentrate; and
wherein said partially water-soluble solvent has a solubility in water at 20° C. to 25° C. of 0.01 to 10% w/w.

In a preferred embodiment of the invention, a composition comprising
a first agrochemical, wherein said first agrochemical is oxathiapiprolin;
a second agrochemical, wherein said second agrochemical is metalaxyl-M;
at least one component selected from a surfactant, an emulsifier, and a dispersing agent; and
a solvent system, that dissolves said first and second agrochemical, comprising:
a water-soluble solvent, and
a partially water-soluble;
wherein the composition is a dispersible concentrate; and
wherein said partially water-soluble solvent has a solubility in water at 20° C. to 25° C. of 0.01 to 5% w/w.

In a more preferred embodiment of the invention, a composition comprising
a first agrochemical, wherein said first agrochemical is oxathiapiprolin;
a second agrochemical, wherein said second agrochemical is metalaxyl-M;
at least one component selected from a surfactant, an emulsifier, and a dispersing agent; and
a solvent system, that dissolves said first and second agrochemical, comprising:
a water-soluble solvent, and
a partially water-soluble;
wherein the composition is a dispersible concentrate; and
wherein said partially water-soluble solvent has a solubility in water at 20° C. to 25° C. of 0.01 to 1% w/w.

### Surfactants

In general, embodiments of the disclosure include at least one surfactant. The composition can comprise from 5% to 40% by weight of a surfactant, preferably from 10% to 30% by weight of surfactant, and more preferably from about 15% to about 30% or about 20% to about 30% by weight of surfactant, over the total weight of the composition. In embodiments where more than one surfactant is used (for example: a first and second surfactant; or a first, second, and third surfactant; etc), each surfactant can be present in various amounts, for example: 1%, 2%, 3%, 4%, 5%, 6%, 7%, 8%, 9%, 10%, 11%, 12%, 13%, 14%, 15%, 16%, 17%, 18%, 19%, 20%, 21%, 22%, etc. by weight and ranges created in between any two numbers listed above. For example, 1% to 15% by weight; or 1% to 10% by weight; 5% to 15% by weight; 10% to 20% by weight; 4% to 6% by weight; 4% to 7% by weight, etc. The surfactant can be selected to facilitate compatibility of the partially water-soluble solvent with the remainder of the composition. Emulsifiers and dispersing agents can be subsets of surfactants.

### Emulsifier

The composition of the present disclosure can further comprise one or several emulsifiers. More particularly, the composition can comprise from 0.01% to 40% by weight of emulsifier, preferably from 0.5% to 30% by weight of emulsifier, and more preferably from 0.5% to 20% by weight of emulsifier, based on the total weight of the composition.

The emulsifiers can be surfactants well-known in the art, such as ionic (anionic, cationic, or amphoteric) and non-ionic surfactants.

Suitable ionic surfactants are the alkali, alkaline earth and ammonium salts of aromatic sulfonic acids, for example of lignosulfonic acid, phenolsulfonic acid, naphthalenesulfonic acid, dibutylnaphthalenesulfonic acid or of fatty acids, alkyl- and alkylarylsulfonates, alkylsulfates, lauryl ether sulfates and fatty alcohol sulfates, and salts of sulfated hexa-, hepta- and octa-decanols, and of fatty alcohol glycol ethers, condensates of sulfonated naphthalene and its derivatives with formaldehyde, condensates of naphthalene or of the naphthalenesulfonic acids with phenol and formaldehyde, polycarboxylates, or phosphate esters of alkoxylated alcohols.

Suitable non-ionic surfactants are polyoxyethylene octyl phenol ethers, alkoxylated alcohols such as ethoxylated alkyl phenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, tristyrylphenol ethoxylates, polyoxyethylene alkyl ethers or polyoxypropylene alkyl ethers, lauryl alcohol polyglycol ether acetate, sorbitol esters, fatty acid ethoxylates, alkyl polyglucosides, lignin-sulfite waste liquors and also proteins, denatured proteins, polysaccharides (for example methylcellulose), hydrophobically modified starches, polyvinyl alcohols (for example Mowiol®), polyalkoxylates, polyvinylamines, polyethyleneimines, polyvinylpyrrolidones and their copolymers or block polymers.

In a preferred embodiment, the emulsifier can be selected among non-ionic surfactants. For example, the composition can comprise a sorbitol ester and a polyoxyalkylene copolymer, respectively in an amount from 1% to 20% by weight over the total weight of the composition. A preferred embodiment is a composition according to the invention comprising from 1% to 10% by weight of sorbitol ester and from 1% to 10% by weight of polyoxyalkylene copolymer, over the total weight of the composition.

The sorbitol ester can be more particularly a polyoxyethylene sorbitan trioleate. For example, the sorbitol ester can be Tween 85, supplied by CRODA.

The polyoxyalkylene copolymer can be obtained from at least two different alkylene oxides, such as from ethylene oxide and propylene oxide monomers.

The polyoxyalkylene copolymer can be preferably a polyoxyalkylene block copolymer of the AB, ABA, BAB, or ABABA type.

More particularly, the polyoxyalkylene copolymer can be prepared by ring-opening polymerization of the corresponding cyclic ethylene oxide and propylene oxide monomers.

Typically, the ring-opening polymerization is initiated by addition of water and alkali hydroxides, such as sodium hydroxide and potassium hydroxide. The block structure of the copolymer is formed by first polymerizing a polymer block using one monomer, before adding a second monomer to form further polymer blocks.

In a preferred embodiment, the polyoxyalkylene copolymer can be an ethylene oxide-propylene oxide-ethylene oxide block copolymer (EO-PO-EO block copolymer), or in other words a poly(ethylene oxide)-poly(propylene oxide)-poly(ethylene oxide) block copolymer or a poly(ethylene glycol)-poly(propylene glycol)-poly(ethylene glycol) block copolymer.

In another preferred embodiment, the polyoxyalkylene copolymer can be an ethylene oxide-propylene oxide block copolymer (EO-PO block copolymer), or in other words a poly(ethylene oxide)-poly(propylene oxide) block copolymer or a poly(ethylene glycol)-poly(propylene glycol) block copolymer.

The polyoxyalkylene copolymer of the invention can have an average molecular weight from 1,000 to 15,000 g/mol, and preferably from 3,000 to 7,000 g/mol. Molecular weight of a polymer, or in other words the molar mass, can be easily determined by methods well-known in the art, such as gel permeation chromatography (GPC).

Examples include the GENAPOL® PF series (CLARIANT), the PLURONIC® series (BASF), the SYNPERONIC® PE series (CRODA), or the TOXIMUL® series (STEPAN). As a preferred example, the polyoxyalkylene copolymer can be a butyl polyalkylene oxide block copolymer, such as Toximul 8320 supplied by STEPAN.

Other suitable emulsifiers are non-ionic amphoteric emulsifier, for example emulsifiers containing a polyethylene oxide moiety. Such emulsifiers are generally known to the skilled person. Non-ionic amphoteric emulsifier comprising a polyethylene oxide moiety may be selected from fatty alcohol alkoxylates, preferably ethoxylated C₁₂-C₁₈ alcohols, such as isotridecyl alcohol that is ethoxylated with two ethylene oxide moieties (e.g. the Lutensol TO series of BASF); polyalkoxylates, preferably copolymers of ethylene oxide and propylene oxide (e.g. Step Flow LF or Genapol PF10); copolymers and block copolymers of glycerol with hydroxylated saturated and unsaturated fatty acids, such as polyglyceryl-2 dipolyhydroxystearate (e.g. Dehymuls PGPH); ethoxylated glycerol esters of hydroxy fatty acids and their derivatives, such as ethoxylated castor oil (e.g., Toximul® 8241, Toximul® 8240), ethoxylated and hydrogenated castor oil, or ethoxylated castor oil oleate (e.g. Toxium 8248, Toximul 8243, Alkamuls V02003 or Emulsogen ELO200); polyether siloxanes (e.g. Break Thru OE 440), nonionic modified polyesand ters (e.g. Tersperse 2520), or polyglycerol fatty acid partial esters (e.g., Tego XP11041).

Ethoxylated castor oil emulsifier is produced by the reaction of castor oil with ethylene oxide. Ethoxylated castor oil emulsifiers are of various chain lengths, depending on the quantity of ethylene oxide used during synthesis. The molar ratio can vary from 1 molecule of castor oil to 1-200 molecules of ethylene oxide, producing an ethoxylated castor oil emulsifier named PEG-x (polyethylene glycol) castor oil emulsifier, where x is the number of ethylene oxide moieties (Fruijtier-Polloth, C. Toxicology 2005, “Safety assessment on polyethylene glycols (PEGs) and their derivatives as used in cosmetic products”, 214, 1-38). In one embodiment the emulsifier used in the composition according to the present invention can be selected from non-ionic surfactants, e.g., a polyoxyalkylene copolymer; a non-ionic amphoteric emulsifier, comprising a polyethylene oxide moiety, e.g., ethoxylated castor oil emulsifiers; a sorbitol, e.g., Tween® 80; and an alkylaryl sulfonate, such as for example Nansa® EVM63/B.

In another embodiment the emulsifier used in the composition according to the present invention can be selected from non-ionic surfactants, e.g., a polyoxyalkylene copolymer (as for example commercially available Toximul®8320); a non-ionic amphoteric emulsifier, comprising a polyethylene oxide moiety, e.g., ethoxylated castor oil emulsifiers (for example commercially available Toximul®8240); a sorbitol, e.g., Tween® 80; and an alkylaryl sulfonate, such as for example commercially available Nansa® EVM63/B.

### Dispersing Agents

The compositions of the disclosure can further comprise one or several dispersing agents. More particularly, the composition can comprise from 0.01% to 20% by weight of dispersing agent, and preferably from 0.5% to 10% by weight of dispersing agent, over the total weight of the composition.

In specific embodiments, a dispersing agent is not needed. In these embodiments, the composition will be free of a dispersing agent.

In a preferred embodiment, the dispersing agent can be an acrylic graft copolymer.

The acrylic graft copolymer typically has a comb- or star-like structure, and preferably a comb-like structure. Graft copolymers are branched copolymers wherein the components forming the side chains are structurally different from the components forming the main chain. Comb-like polymers comprise of a main chain (backbone) which contains branch points from each of which a linear side chain emanates. Star-like polymers comprise of a multifunctional centre from which at least three polymer chains radiate.

In a preferred embodiment, the acrylic graft copolymer can be an amphipathic copolymer.

More particularly, the acrylic graft copolymer comprises at least one component A, which is solvated by an aqueous medium (hydrophilic part), and at least one other component B which is hydrophobic.

Suitable acrylic graft copolymers may comprise polyethylene glycol, mono-methyl ethers of polyethylene glycol, poly(vinyl pyrrolidone), poly(acrylamide) or poly(vinyl alcohol) as hydrophilic side chain, while the hydrophobic backbone may comprise polymers and copolymers of styrene, methyl acrylate, methyl methacrylate, ethyl acrylate, 2-ethylhexyl acrylate, lauryl methacrylate, or vinyl acetate.

Such acrylic graft copolymers can for example be prepared by converting the mono-methyl ether of a polyethylene glycol to the acrylic or methacrylic ester, which is then subjected to radical polymerization with other unsaturated monomers such as styrene, ethyl acrylate, or methyl methacrylate. It is also possible to prepare such acrylic graft copolymers by reacting a hydrophobic polymer backbone, which consists chemically reactive sites such as carboxyl, hydroxy, or amine groups, with monomeric alkylene oxides, such as ethylene oxide and propylene oxide, to form hydrophilic side chains.

More preferably, the acrylic graft copolymer is a non-ionic polymer, and more particularly with a comb-like structure.

In the present disclosure, the acrylic graft copolymer can comprise polyethylene glycol and/or mono-ether polyethylene glycol side chains.

The acrylic graft copolymer can also comprise a backbone obtained from acrylate and/or methacrylate monomers.

Even more preferably, the acrylic graft copolymer can comprise a backbone obtained from acrylate and/or methacrylate monomers, and side chains comprising polyethylene glycol and/or mono-ether polyethylene glycol, giving more particularly the polymer a comb-like structure.

For example, the acrylic graft copolymer can be Atlox 4913™ supplied by CRODA, or Tersperse 2500™ supplied by HUNTSMAN.

### Additional Components

The composition of the invention can further comprise one or more formulation additives well-known in the art. In particular, the formulation additives can be selected among an anti-foam agent, a wetting agent, an anti-freeze agent, an anti-bacterial agent (or biocide), a viscosity modifier, a pH modifier, and any mixture thereof, and preferably the formulation additives can be selected among an anti-foam agent, a wetting agent, and any mixture thereof.

Each of the above-cited formulation additives can be added into the composition to obtain the desired property. For example, each of the formulation additives can be added into the composition in an amount from 0.0001% to 10% by weight, and preferably from 0.001% to 5% by weight, over the total weight of the composition.

Other suitable formulation additives include amongst others known to the person skilled in the art, antioxidant, colourant, perfume, adjuvant, attractant, binder, solid support (carrier), coating agent, deodorant, emetic agent, inorganic filler, safener, and any mixture thereof.

The composition of the present invention may comprise a suitable amount of one or several of the above-mentioned ingredient(s) to obtain the respective properties, when appropriate.

### Methods of Use

In a particular embodiment, the composition of the present disclosure may relate to:
a. a concentrate designed to be added to a farmer's spray tank of water or it may be applied directly without further dilution, or
b. a suspension produced in a farmer's spray tank of water when a concentrate is mixed with water in the spray tank.

Another object of the present disclosure relates to a method of controlling or preventing an infestation of plants by fungal organisms, which comprises the following applications of the composition according to the present disclosure: foliar application, soil application and/or tree injection.

In the foliar method or in the soil method, the composition of the present disclosure can be generally applied by spraying the composition; for example, dispensed from a spray container.

In general, high dilution applications involve diluting 200-20′000 times, preferably 200-15′000 times, and most preferably 300-5′000 times. Low dilution applications involve diluting 1-500 times, preferably 2-200 times, and most preferably 5-100 times.

Soil or foliar methods can involve an effective amount of the composition applied at a rate of from 0.01 to 5 Litre per Hectare (L/ha), and preferably from 0.02 to 3.0 L/ha.

Another object of the present disclosure relates to use of the composition to control or prevent an infestation of plants by fungal organisms, especially against oomycete pathogens (e.g., Phytophthora species, downy mildews).

The plants can be selected among grapes, vegetables, speciality crops, and permanent crops, and can be for example Cucurbitaceae (melon, watermelon, squash, pumpkin, zucchini, cucumber); Solanaceae (tomato, pepper, green tomato, eggplant); leafy vegetables (lettuce, chard, spinach, celery); Alliums (onion, green onion, garlic, leek); peas; Brassicaceae (broccoli, cauliflower, brussel sprouts, cabbage); grapes; permanent crops like for example pineapple; citrus; black pepper; cardamom; durian; avocado, treenuts, mango, tobacco, ginseng, hops, berries (e.g., strawberries, caneberries, bushberries), sugarcane, or snapbean and peanuts.

Preferred crops are selected from tubers, such as potatoes. and other ouberous and corm vegetables.

Embodiments according to the invention are provided as set out below. The following provides nonlimiting embodiments of the disclosure.

Embodiment 1. A composition, comprising:
a first agrochemical;
a second agrochemical;
at least one component selected from a surfactant, an emulsifier, and a dispersing agent; and
a solvent system, that dissolves the first and second agrochemical, comprising:
a water-soluble solvent, and
a partially water-soluble;
wherein the composition is a dispersible concentrate; and
wherein the first agrochemical is different from the second agrochemical.

Embodiment 2. The composition of embodiment 1, wherein the first agrochemical is oxathiapiprolin.

Embodiment 3. The composition of embodiment 1, wherein the first agrochemical is metalaxyl-M.

Embodiment 4. The composition of embodiment 1, wherein the first agrochemical is oxathiapiprolin and the second agrochemical is metalaxyl-M.

Embodiment 5. The composition of any one of embodiments 1-4, wherein the water-soluble solvent has a solubility of at least 10% w/w, preferably 50% w/w, and most preferably 90% w/w, 91% w/w, 92% w/w, 93% w/w, 94% w/w, 95% w/w, 96% w/w, 97% w/w, 98% w/w, 99% w/w, or 100% w/w (completely miscible).

Embodiment 6. The composition of any one of embodiments 1 to 4, wherein the water-soluble solvent is dipropylene glycol monomethyl ether; ethyl lactate; n-propyl-L-lactate; methyl L-lactate; N-methyl pyrrolidinone; 4-methyl-1,3-dioxolan-2-one; or tetrahydrofurfuryl alcohol.

Embodiment 7. The composition of any one of embodiments 1 to 4, wherein the water-soluble solvent is a ester-amide derivative of lactic acid.

Embodiment 8. The composition of any one of embodiments 1 to 4, wherein the water-soluble solvent is N,N-dimethyl lactamide.

Embodiment 9. The composition of any one of embodiments 1 to 8, wherein the partially water-soluble solvent has a solubility of 0.01 to 10% w/w, preferably 0.01 to 5% w/w, and most preferably 0.1-1% w/w.

Embodiment 10. The composition of any one of embodiments 1 to 8, wherein the partially water-soluble solvent is benzyl acetate; butyl acetate and isomers; n-butyl L-lactate; mixture of N, N-dimethyloctanamide and N, N dimethyldecanamide; cyclohexanone; or isophorone.

Embodiment 11. The composition of any one of embodiments 1 to 8, wherein the partially water-soluble solvent is an aromatic ketone.

Embodiment 12. The composition of any one of embodiments 1 to 8, wherein the partially water-soluble solvent is acetophenone.

Embodiment 13. The composition of any one of embodiments 1 to 8, wherein the partially water-soluble solvent is a lactic acid ester-derivative.

Embodiment 14. The composition of any one of embodiments 1 to 8, wherein the partially water-soluble solvent is 2-ethylhexyl-S-lactate.

Embodiment 15. The composition of any one of embodiments 1 to 14, wherein the solvent system further comprises a second partially water-soluble solvent which has a different affinity to water than the first partially water-soluble solvent.

Embodiment 16. The composition of embodiment 15, wherein the partially water-soluble solvent is an aromatic ketone, and the second partially water-soluble solvent is a lactic acid ester-derivative.

Embodiment 17. The composition of embodiment 16, wherein the partially water-soluble solvent is acetophenone and the second partially water-soluble solvent is 2-ethylhexyl-S-lactate.

Embodiment 18. The composition of embodiment 1, wherein:
the first agrochemical is oxathiapiprolin,
the second agrochemical is metalaxyl-M,
the water-soluble solvent is an ester-amidederivative of lactic acid;
the partially water-soluble solvent is an aromatic ketone;
the solvent system further comprises a second partially water-soluble solvent which is a lactic acid ester-derivative.

Embodiment 19. The composition of embodiment 18, wherein:
the water-soluble solvent is N,N-dimethyl lactamide;
the partially water-soluble solvent is acetophenone; and
the second partially water-soluble solvent is 2-ethylhexyl-S-lactate.

Embodiment 20. The composition of any one of embodiments 1 to 19, wherein the total amount of agrochemical present in the composition is 1 to 40% w/w, preferably from 1 to 30% w/w, and most preferably 5 to 20% w/w.

Embodiment 21. The composition of any one of embodiments 1 to 20, wherein the first agrochemical is present in the composition at 1 to 20% w/w, preferably 1 to 10% w/w, and most preferably 1 to 5% w/w.

Embodiment 22. The composition of any one of embodiments 1 to 21, wherein the second agrochemical is present in the composition at 1 to 30% w/w, preferably 5 to 30% w/w, and most preferably 5 to 25% w/w.

Embodiment 23. The composition of any one of embodiments 1 to 22, wherein the total amount of solvent present in the composition is 40 to 80% w/w, preferably 50 to 70% w/w, and most preferably 55 to 65% w/w.

Embodiment 24. The composition of any one of embodiments 1 to 23, wherein the water-soluble solvent is present in the composition at 10 to 40% w/w, preferably 10 to 30% w/w, and most preferably 15 to 25% w/w.

Embodiment 25. The composition of any one of embodiments 1 to 24, wherein the partially water-soluble solvent is present in the composition at 5 to 25% w/w, preferably 5 to 20% w/w, and most preferably 10 to 20% w/w.

Embodiment 26. The composition of any one of embodiments 1 to 25, wherein the second partially water-soluble solvent when present is present in the composition at 5 to 25% w/w, preferably 5 to 20% w/w, and most preferably 10 to 20% w/w.

Embodiment 27. The composition of any one of embodiments 1 to 27, wherein the ratio of water-soluble solvent to partially water-soluble solvent is 1:9 to 9:1, preferably 1:5 to 5:1, and most preferably 1:3 to 3:1.

Embodiment 28. The composition of any one of embodiments 1 to 27, wherein when the second partially water-soluble solvent is present, the ratio of the partially water-soluble solvent to the second partially water-soluble solvent is 1:9 to 9:1, preferably 1:4 to 4:1, and most preferably 1:3 to 3:1.

Embodiment 29. The composition of any one of embodiments 1 to 28, wherein the at least one component selected from a surfactant, an emulsifier, and a dispersing agent is present at 0.01 to 40%.

Embodiment 30. The composition of embodiment 29, wherein the at least one component selected from a surfactant, an emulsifier, and a dispersing agent is selected from at least one of polyoxyalkylene copolymer (such as for example Toximul®8320), an ethoxylated castor oil (such as for example Toximul®8240), a sorbitol (such as for example Tween®80), and an alkylaryl sulfonate (such as for example Nansa® EVM63/B).

Embodiment 31. The composition of any one of embodiments 1 to 30, wherein the composition further comprises an antifoam agent.

Embodiment 32. The composition of any one of embodiments 1 to 31, wherein the composition is free of a dispersant or crystal growth inhibitor.

Embodiment 33. A method, comprising diluting the composition of embodiment 1 with water.

Embodiment 34. The method of embodiment 33, wherein diluting is 1-20′000 times, preferably 2-15′000 times, and most preferably 5-5′000 times.

Embodiment 35. The method of embodiment 34, further comprising applying an agrochemically effective amount of the diluted composition to a pest, a plant susceptible to attack from the pest, or a locus of the pest susceptible to attack from the pest.

Embodiment 36. The composition of any one of embodiments 1 to 32, wherein the particulate size of the agrochemicals in the composition substantially remains below 300 microns after dilution with water.

Embodiment 37. A composition, comprising:
oxathiapiprolin;
metalaxyl-M;
at least one component selected from a surfactant, an emulsifier, and a dispersing agent; and
a solvent system, comprising:
a water-soluble solvent,
a first partially water-soluble solvent, and
a second partially water-soluble solvent.

Embodiment 38. The composition of embodiment 37, wherein the composition is a dispersible concentrate.

Embodiment 39. The composition of either embodiment 37 or 38, wherein the total amount of agrochemical present in the composition is 5 to 20% w/w.

Embodiment 40. The composition of embodiment 39, wherein the total amount of solvent present in the composition is 40 to 80% w/w.

Embodiment 41. The composition of embodiment 40, wherein:
the water-soluble solvent is an ester-amide derivative of lactic acid;
the first partially water-soluble solvent is an aromatic ketone; and
the second partially water-soluble solvent which is a lactic acid ester-derivative.

Embodiment 42. The composition of embodiment 40, wherein:
the water-soluble solvent is N,N-dimethyl lactamide;
the first partially water-soluble solvent is acetophenone; and
the second partially water-soluble solvent which is 2-ethylhexyl-S-lactate.

Embodiment 43. The composition of embodiment 40, wherein the ratio of water-soluble solvent to partially water-soluble solvent is 1:3 to 3:1.

Embodiment 44. A composition, comprising:
a first agrochemical;
a second agrochemical;
at least one component selected from a surfactant, an emulsifier, and a dispersing agent; and
a solvent system, that dissolves the first and second agrochemical, comprising:
a water-soluble solvent, and
a partially water-soluble;
wherein the composition is a dispersible concentrate; and
wherein the first agrochemical is different from the second agrochemical.

Embodiment 45. The composition of embodiment 44, wherein:
the total amount of agrochemical present in the composition is 5 to 20% w/w; and
the total amount of solvent present in the composition is 40 to 80% w/w.

Embodiment 46. The composition of embodiment 44, further comprising: 5 to 25% w/w a second partially water-soluble solvent; and
wherein:
the water-soluble solvent is present at 10 to 40% w/w;
the first partially water-soluble solvent is present in the composition at 5 to 25%; and
wherein the ratio of water-soluble solvent to partially water-soluble solvent is 1:3 to 3:1.

Embodiment 47. The composition of embodiment 46, wherein the particulate size of the agrochemicals in the composition substantially remains below 300 microns after diluting in 100-20′000 times water.

Embodiment 48. The composition of embodiment 47, wherein the composition is free of a dispersant or crystal growth inhibitor.

Embodiment 49. A composition, comprising:
a first agrochemical;
at least one component selected from a surfactant, an emulsifier, and a dispersing agent; and
a solvent system, that dissolves the first agrochemical, comprising:
a water-soluble solvent,
a first partially water-soluble, and
a second partially water-soluble;
wherein the composition is a dispersible concentrate; and
wherein said composition further optionally comprises a second agrochemical,
wherein said first agrochemical is different from said second agrochemical.

Embodiment 50. The composition of embodiment 49, wherein:
the water-soluble solvent is an ester-amide derivative of lactic acid derivative;
the first partially water-soluble solvent is an aromatic ketone; and
the second partially water-soluble solvent which is a lactic acid ester-derivative.

Embodiment 51. The composition of embodiment 49, wherein:
the water-soluble solvent is N,N-dimethyl lactamide;
the first partially water-soluble solvent is acetophenone; and
the second partially water-soluble solvent which is 2-ethylhexyl-S-lactate.

Embodiment 52. A method, comprising diluting any of embodiments 37-50 in 100-20′000 times, preferably 2-15′000 times, and most preferably 5-5′000 times water.

Embodiment 53. The method of embodiment 52, further comprising applying an agrochemically effective amount of the diluted composition to a pest, a plant susceptible to attack from the pest, or a locus of the pest susceptible to attack from the pest.

Embodiment 54: The composition of embodiment of embodiment 44 to 49, wherein said partially water-soluble solvent has a solubility in water at 20 to 25° C. of 0.01 to 10% w/w.

Embodiment 55: The composition of embodiment of embodiment 44 to 49, wherein said partially water-soluble solvent has a solubility in water at 20 to 25° C. of 0.01 to 5% w/w.

Embodiment 56: The composition of embodiment of embodiment 44 to 49, wherein said partially water-soluble solvent has a solubility in water at 20 to 25° C. of 0.01 to 1% w/w.

Embodiment 57. The composition of any one of embodiments 1 to 8, wherein the partially water-soluble solvent has a solubility of 0.01 to 10% w/w.

Embodiment 58. The composition of any one of embodiments 1 to 8, wherein the partially water-soluble solvent has a solubility of 0.01 to 5% w/w.

Embodiment 59. The composition of any one of embodiments 1 to 8, wherein the partially water-soluble solvent has a solubility of 0.01 to 1% w/w.

### ABBREVIATIONS

CAS Chemical Abstract Service, Registry Number (CAS or CAS-RN)
DC dispersible concentrate
GPA gallons per acre (gal/ac or GPA)
GPM gallons per minute (gal/min)
HP horsepower (or hp)
n/a not applicable
RT room temperature (RT or rt)US United States of America

### Examples

The following examples illustrate the behaviour associated with a composition according to the present invention.

As used herein, the term “gallon” refers to a unit of volume as used in the US and is defined as 3.785 litre (L).

As used herein, the term “GPA” refers to spray volume in gallons per acre (GPA or gal/ac) as used in the US, wherein 1 gal/ac of volume area equals 9.35 litres per hectare (L/ha).

As used herein, the term “GPM” flow rate” refers to “Gallons Per Minute” flow rate as used in the US, and 1 GPM equals 3.79 litre per minute (L/min).

As used herein, the term “fl oz/ac” refers to a unit of volume (also called capacity) as used in the US, and 1 fl. oz/ac equals 0.0731 litre per hectar (L/ha).

As used herein, the term “horsepower” refers to a unit of measurement of power, or the rate at which work is done, usually in reference to the output of engines or motors. In this case it refers to the ability of a pump on a spray tank or tank to recirculate or spay the diluted product. Horsepower (hp) is a unit of measurement in the foot-pound-second (fps or ft-lb/s). (One (1) horsepower is defined as displaying 1 lb a distance of 33,000 ft in one minute). 1 horsepower equals 745.69 watts, such 0.75 (¾) horsepower (hp) equals 559.3 watts.

The components used in the following examples are detailed as follows:

| | |
|---|---|
| Oxathiapiprolin | a fungicide (CAS number: 1003318-67-9), from Corteva |
| Metalaxyl-M | a fungicide (CAS number: 70630-17-0), from Syngenta |
| Lactic acid | (CAS number: 35123-06-9) is a lactamide compound used as solvent, supplied |
| dimethyl amide | by BASF |
| Acetophenone | (CAS number: 98-86-2) is methyl-phenyl ketone used as solvent, supplied by |
| | AcetoCorp or Solvay |
| Dimethyl | methyl-5-(dimethylamino)-2-methyl-5-oxopentanoate (CAS number: 1174627- |
| amide ether | 68-9), used as solvent, supplied by SOLVAY |
| 2-ethylhexyl- | (CAS: 186817-80-1) is propanoic acid, 2-hydroxy-, 2-ethylhexyl ester used as |
| S-lactate | solvent, supplied by BASF or CORBION |
| Atlox ™ | nonionic polymeric aqueous dispersant comprising around 35% by weight of an |
| 4913-LQ-(MV) | acrylic graft copolymer, supplied by CRODA |
| Toximul ® 8320 | polyoxyalkylene copolymer (CAS Number: 9038-95-3), supplied by STEPAN |
| Toximul ® 8240 | ethoxylated castor oil (36 mole EO) (CAS Number: 61791-12-6), supplied by |
| | STEPAN |
| Tween ® 85 | isorbitol ester (CAS Number: 9005-70-3), supplied by CRODA |
| Anti-foam agent | polydimethylsiloxane CAS Number: (63148-62-9), supplied by DOW |
| Toximul ® 8241 | ethoxylated castor oil (30 mole EO) (CAS Number: 61791-12-6), supplied by |
| | STEPAN |
| Tween ® 80 | ethoxylated (20 mole EO) sorbitan monooleate (CAS Number: 9005-65-6), |
| | supplied by CRODA |
| Nansa ® EVM 63/B | dodecybenzene sulfonate calcium salt in isobutanol, (CAS Number: 68584-23- |
| | 6) supplied by Innospec |
| Bio-Soft ® | anionic surfactant comprising a triethanolamine salt of linear alkylbenzene |
| N-300 | sulfonic acid, comprising dodecylbenzene sulfonate triethanolamine salt (CAS |
| | Number: 64811314, 121617-08-1) supplied by Stephan |
| Genapol ® | nonionic surfactant, an alcohol ethoxylate based on naturally derived fatty |
| O-100 | alcoholethoxylated (10 mole EO) oleyl alcohol, (CAS Number: 9004-98-2) |
| | supplied by Clariant |
| Rhodasurf ® | nonionic surfactant, comprising ethoxylated (6 mole EO) isotridecyl alcohol, |
| BC-610 | (CAS Number: 78330-21-9, 9043-30-5) supplied by Solvay |
| Agnique ® | water-soluble nonionic emulsifier, ethoxylated castor oil (POE 36), |
| CSO-36 | supplied by BASF |
| Agnique ® | alkylpolyglucoside, (CAS Number: 68515-73-1) supplied by BASF |
| APG 8107 | |
| Agnique ® | lactic acid dimethyl amide, Propanamide, 2-hydroxy-N,N-dimethyl (CAS No.: |
| AMD 3L | 35123-06-9), supplied by BASF |
| Rhodiasolv ® | water soluble polar solvent, methyl 5-(dimethylamino)-2-methyl-5- |
| Polarclean | oxopentanoate (CAS No.: 1174627-68-9), supplied by Solvay |
| Break-thru ® | polymeric, non-ionic dispersing agent and emulsifier, non-ionic surfactant, |
| DA647 | Oxirane, 2-phenyl-, polymer with oxirane, monooctyl ether, (CAS No. 83653-00- |
| | 3), supplied by Evonik |
| Break-thru ® | non-ionic trisiloxane surfactant, Oxirane, methyl-, polymer with oxirane, mono[3- |
| S-233 | [1,3,3,3-tetramethyl-1-[(trimethylsilyl)oxy]disiloxanyl]propyl] ether, (CAS No. |
| | 134180-76-0), supplied by Evonik |
| Stepwet ® | anionic surfactant comprising sodium lauryl sulfate, (CAS No. 68585-47-7), |
| DF-95 | supplied by Stepan |
| XIAMETER ™ | Non-ionic antifoam emulsion agent comprising active silicone emulsion, supplied |
| AFE-1510 | by DOW Chem. Comp. |

### Example 1

Each sample was prepared by mixing the individual ingredients together, then by gently warming around 3500, and by stirring the mixture until a uniform solution was achieved, which was then allowed to cool to room temperature (20°).

The concentrations of the components added to form the compositions of Composition 1 and Composition A are listed in the below Table 1, and are expressed in percentage by weight, based on the total weight of the composition (% w/w).

TABLE 1
composition 1 and composition A

| | | Composition 1 | Composition A |
|---|---|---|---|
| Component | Purpose | (% w/w) | (% w/w) |
| Oxathiapiprolin | Agrochemical | 3.37 | 3.2 |
| Metalaxyl-M | Agrochemical | 10.1 | 9.8 |
| polyoxyalkylene | emulsifier | 5 | 4.7 |
| copolymer | | | |
| (Emulsifier 1)¹ | | | |
| ethoxylated | emulsifier | add 100 (rest) | 0 |
| castor oil | | | |
| (Emulsifier 2)² | | | |
| Tween ® 80 | emulsifier | 0 | 4.7 |
| (Emulsifier 3) | | | |
| Anti-foam agent | antifoam | 0.01 | 0.005 |
| 2-ethylhexyl- | solvent | 20 | 0 |
| S-lactate | | | |
| Acetophenone | solvent | 20 | 0 |
| Lactic acid | solvent | 20 | 0 |
| dimethyl amide | | | |
| Dimethyl amide | solvent | n/a | add 100 (rest) |
| ether | | | |
| Atlox ™ | dispersant, growth | n/a | 5.8 |
| 4913-LQ-(MV) | inhibitor | | |

¹Emulsifier 1 used in the invention refers to a polyoxyalkylene copolymer, as for example commercially available Toximul ®8320
²Emulsifier 2 used in the invention refers to ethoxylated castor oil emulsifiers, for example commercially available Toximul ®8240

The different behaviour of Composition 1, dispersible concentrate (DC) according to the present invention, and Composition A, comparative dispersible concentrate (DC) of oxathiapiprolin and metalaxyl-M in dimethyl amide ether as solvent system, during spray application was tested at lab scale under various conditions

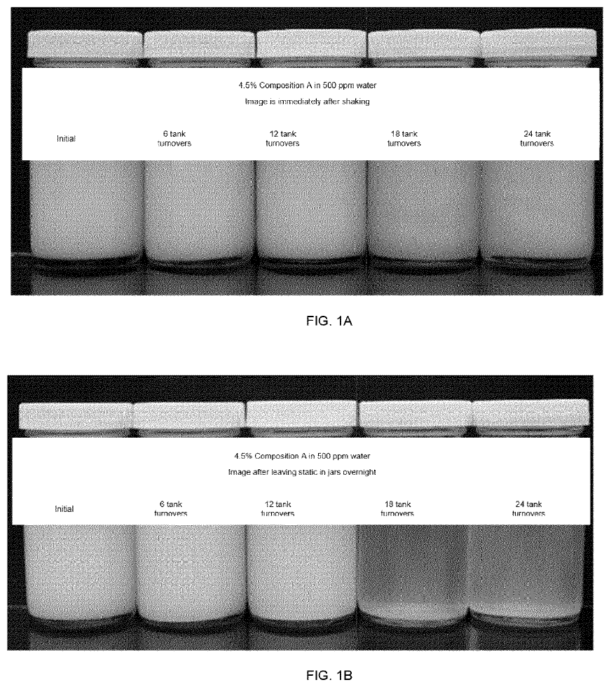

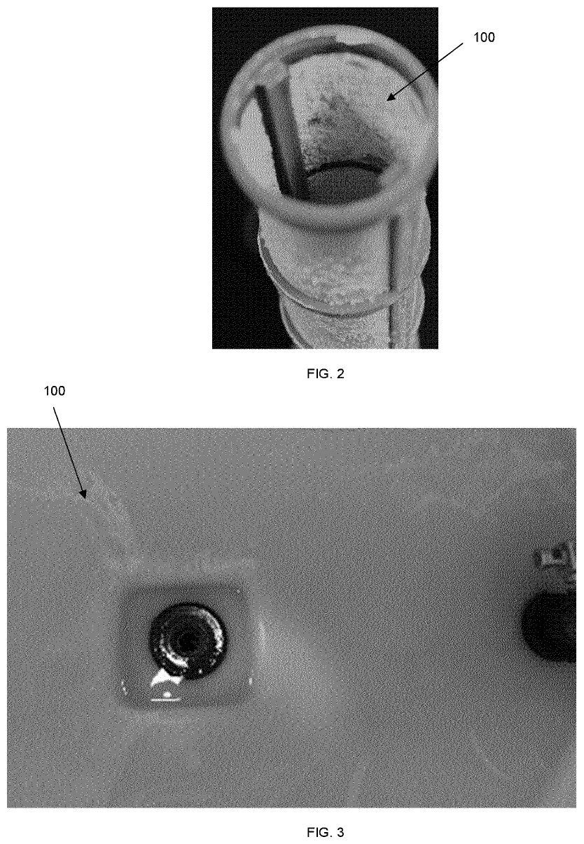

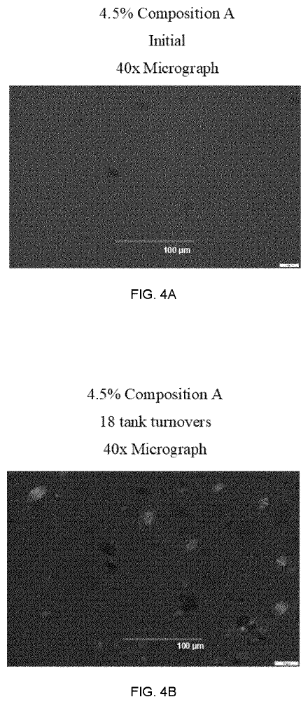

Testing Composition A, lab scale failure was created using 20 gallon spray equipment: tank, pump with a metric horsepower of 559.3 watts., 3450 RPM centrifugal pump, 27-30 PSI pressure, 1-1.3 GPM flow rate. Crystals with a length of 5-10 μm were present in the tank-mix after about 12 tank turnovers (2 hours of continues agitation). A sandy residue began to build-up on the inline filter and on the walls of the spray tank with cumulative build-up with subsequent loads. Test conditions were set at four 10-gallon loads with three hours of agitation per load. Results are shown in the images of FIGS. 1A, 1B, 2, 3, 4A, and 4B. In FIGS. 2 and 3 reference numeral 100 indicates residue build up.

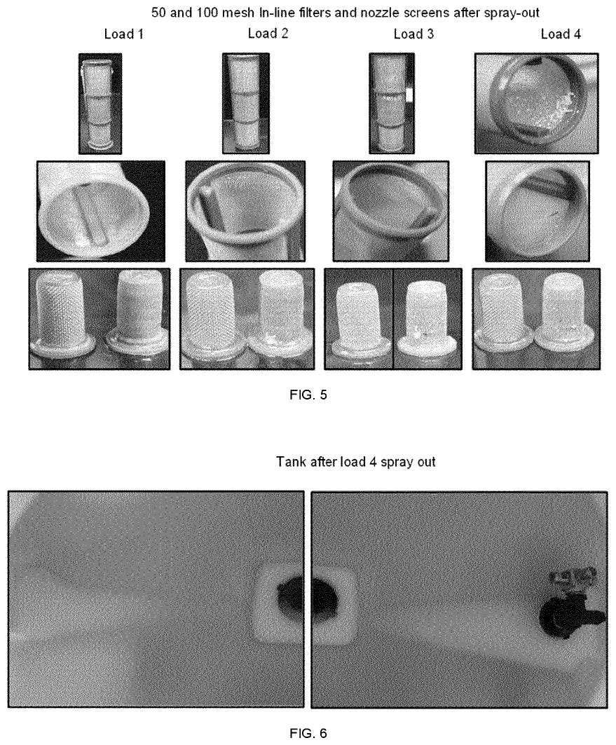

Composition 1 was tested with a spray volume of 5 GPM, test conditions: RT, 500 ppm water, 4×10 gal loads, 3 hours agitation per load. Minimal foam on initial mixing and at the end of spray-out for each spray-out was observed. Spray-out of all four loads was completed without significant issues. Trace residue on 50 and 100 mesh in-line filters and nozzle screens. No residue remained in the tank after spray-out. No significant cumulative build-up after four loads. Results are shown in the images of FIGS. 5 and 6.

In general, results from lab scale spray application testing conducted under various conditions including those where the Composition A failed (28 fl. oz./ac; 5 GPA spray volume). Composition 1 passed multi-load shear stress spray tests at typical use rates in hard water at different spray volumes (5 GPA, 15 GPA, 200 GPA). The product (after freeze thaw cycling) also passed multi-load testing at typical use rates in hard water with high alkalinity and lower spray volume (5 GPA) under cold conditions. Good dispersion, low foaming, and minimal residue accumulation on filters or in the tank was demonstrated.

### Example 2

Other formulations with different combinations of co-formulants appeared to have similar properties to Composition 1. The following compositions of Table 2 were tested and rated from A to D (where: A=excellent; B=good; C=fair; D=poor). Ratings for compositions labelled “¹” indicates physical stability in a container up to two weeks and “2” indicates dilution lab scale dilution performance.

TABLE 2A

| | Ex. 1^{1, 2} | Ex. 2^{1, 2} | Ex. 3^{1, 2} |
|---|---|---|---|
| Material | % w/w | % w/w | % w/w |
| Oxathiapiprolin | 3.30 | 3.30 | 3.30 |
| Mefenoxam | 9.92 | 9.92 | 9.92 |
| Agnique ® AMD 3L | 49.00 | 49.00 | 49.00 |
| Rhodiasolv ® Polarclean | 23.43 | 0 | 8.465 |
| Butyl Lactate | 0 | 22.43 | 13.96 |
| Antifoam | 0.01 | 0.01 | 0.01 |
| Atlox ® 4913 | 5.9 | 5.9 | 5.9 |
| Tween ® 85 | 4.72 | 4.72 | 4.72 |
| Toximul ® 8320 | 4.72 | 4.72 | 4.72 |
| RATING | A, B | B, D | B, B |

TABLE 2B

| | Ex. 4^{1, 2} | Ex. 5^{1, 2} | Ex. 6^{1, 2} | Ex. 7^{1, 2} | Ex. 8^{1, 2} |
|---|---|---|---|---|---|
| Material | % w/w | % w/w | % w/w | % w/w | % w/w |
| Oxathiapiprolin | 3.30 | 3.30 | 3.30 | 3.30 | 3.30 |
| Mefenoxam | 9.92 | 9.92 | 9.92 | 9.92 | 9.92 |
| Agnique ® AMD 3L | 49.00 | 49.00 | 49.00 | 49.00 | 49.00 |
| Rhodiasolv ® Polarclean | 0 | 8.47 | 0 | 0 | 0 |
| Acetophenone | 22.43 | 13.96 | 22.43 | 22.43 | 22.43 |
| antifoam | 0.01 | 0.01 | 0.01 | 0.01 | 0.01 |
| Atlox ® 4913 | 5.9 | 5.9 | 0 | 0 | 5.9 |
| Tween ® 85 | 4.72 | 4.72 | 0 | 0 | 0 |
| Toximul ® 8320 | 4.72 | 4.72 | 0 | 0 | 4.72 |
| Nansa EVM ® 63/B | 0 | 0 | 3 | 9 | 0 |
| Toximul ® 8240 | 0 | 0 | 12.34 | 6.34 | 4.72 |
| RATING | A, B | A, B | D, C | D, D | D, C |

TABLE 2C

| | Ex. 9^{1,2} | Ex. 10^{1,2} | Ex. 11^{1,2} | Ex. 12^{1,2} | Ex. 13^{1,2} | Ex. 14^{1,2} |
|---|---|---|---|---|---|---|
| Material | % w/w | % w/w | % w/w | % w/w | % w/w | % w/w |
| Oxathiapiprolin | 3.30 | 3.30 | 3.30 | 3.30 | 3.30 | 3.30 |
| Mefenoxam | 9.92 | 9.92 | 9.92 | 9.92 | 9.92 | 9.92 |
| Agnique ® AMD 3L | 49.00 | 49.00 | 49.00 | 49.00 | 49.00 | 49.00 |
| Atlox ® 4913 | 5.9 | 5.9 | 5.9 | 5.9 | 0 | 0 |
| Tween ® 85 | 4.72 | 4.72 | 4.72 | 4.72 | 0 | 0 |
| Toximul ® 8320 | 4.72 | 4.72 | 4.72 | 4.72 | 0 | 0 |
| Nansa EVM ® 63/B | 0 | 0 | 0 | 0 | 3 | 3 |
| Toximul ® 8240 | 0 | 0 | 0 | 0 | 12.34 | 12.34 |
| antifoam | 0.01 | 0.01 | 0.01 | 0.01 | 0.01 | 0.01 |
| Butyl Lactate | 0 | 0 | 0 | 0 | 0 | 22.45 |
| Rhodiasolv ® Polarclean | 0 | 10 | 0 | 10 | 0 | 0 |
| Dowanol ® DPM | 22.45 | 12.45 | 0 | 12.45 | 0 | 0 |
| 2-ethylhexyl-S-lactate | 0 | 0 | 22.45 | 0 | 22.45 | 0 |
| RATING | C, C | C, B | B, B | B, A | D, A | D, D |

TABLE 2D

| | Ex. 15² | Ex. 16^{1,2} | Ex. 17² | Ex. 18² | Ex. 19² | Ex. 20^{1,2} | Ex. 21^{1,2} | Ex. 22² |
|---|---|---|---|---|---|---|---|---|
| Material | % w/w | % w/w | % w/w | % w/w | % w/w | % w/w | % w/w | % w/w |
| Oxathiapiprolin | 2.48 | 3.32 | 3.30 | 3.65 | 3.30 | 3.32 | 3.30 | 3.32 |
| Mefenoxam | 7.42 | 9.97 | 9.90 | 9.97 | 9.90 | 9.97 | 9.90 | 10.47 |
| Acetophenone | 22.5 | 20 | 20 | 20 | 20 | 20 | 20 | 20 |
| Agnique ® AMD 3L | 22.5 | 20 | 20 | 20 | 25 | 20 | 20 | 20 |
| 2-ethylhexyl-S-lactate | 20 | 20 | 20 | 20 | 15 | 20 | 20 | 20 |
| antifoam | 0.01 | 0.01 | 0.01 | 0.01 | 0.01 | 0.01 | 0.01 | 0.01 |
| Toximul ® 8240 | 20.09 | 21.7 | 0 | 21.37 | 12.29 | 0 | 15.89 | 0 |
| Agnique ® CSO-36 | 0 | 0 | 0 | 0 | 0 | 0 | 0 | 21.2 |
| Toximul ® 8320 | 5 | 5 | 5 | 5 | 5 | 5 | 5 | 5 |
| Atlox ® 4913 | 0 | 0 | 5.9 | 0 | 9.5 | 0 | 5.9 | 0 |
| Tween ® 80 | 0 | 0 | 0 | 0 | 0 | 21.7 | 0 | 0 |
| Rhodasurf ® BC-610 | 0 | 0 | 15.89 | 0 | 0 | 0 | 0 | 0 |
| Break-thru ®DA647 | 0 | 0 | 0 | 0 | 0 | 0 | 0 | 0 |
| RATING | B | B, B | C | B, A | C | A, C | C | B, A |

| | Ex. 23² | Ex. 24^{1,2} | Ex. 25² | Ex. 26^{1,2} | Ex. 27² | Ex. 28^{1,2} | Ex. 29² |
|---|---|---|---|---|---|---|---|
| Material | % w/w | % w/w | % w/w | % w/w | % w/w | % w/w | % w/w |
| Oxathiapiprolin | 3.30 | 3.32 | 3.30 | 3.32 | 3.30 | 3.37 | 2.06 |
| Mefenoxam | 9.90 | 9.97 | 9.90 | 9.97 | 9.90 | 10.1 | 6.19 |
| Acetophenone | 20 | 20.4 | 20 | 19.6 | 20 | 20 | 20 |
| Agnique ® AMD 3L | 20 | 20.4 | 25 | 19.6 | 25 | 20 | 20 |
| 2-ethylhexyl-S-lactate | 20 | 20.4 | 20 | 19.6 | 20 | 20 | 20 |
| antifoam | 0.01 | 0.01 | 0.01 | 0.01 | 0.01 | 0.01 | 0.01 |
| Toximul ® 8240 | 19.79 | 0 | 12.07 | 0 | 0 | 21.52 | 25.74 |
| Agnique ® CSO-36 | 0 | 20.75 | 0 | 22.65 | 0 | 0 | 0 |
| Toximul ® 8320 | 5 | 4.75 | 5 | 5.25 | 5 | 5 | 6 |
| Atlox ® 4913 | 0 | 0 | 4.72 | 0 | 4.72 | 0 | 0 |
| Tween ® 80 | 0 | 0 | 0 | 0 | 12.07 | 0 | 0 |
| Rhodasurf ® BC-610 | 0 | 0 | 0 | 0 | 0 | 0 | 0 |
| Break-thru ®DA647 | 2 | 0 | 0 | 0 | 0 | 0 | 0 |
| RATING | C | B, A | C | B, A | C | B, A | B |

TABLE 2E

| | Ex. | Ex. | Ex. | Ex. | Ex. |
|---|---|---|---|---|---|
| | 30^{1, 2} | 31^{1, 2} | 32^{1, 2} | 33^{1, 2} | 34^{1, 2} |
| Material | % w/w | % w/w | % w/w | % w/w | % w/w |
| Oxathiapiprolin | 3.30 | 3.30 | 3.30 | 3.30 | 3.30 |
| Mefenoxam | 9.92 | 9.92 | 9.92 | 9.92 | 9.92 |
| Acetophenone | 20.00 | 20.00 | 20.00 | 40.00 | 20.00 |
| Agnique ® | 20.00 | 20.00 | 30.00 | 20.00 | 20.00 |
| AMD 3L | | | | | |
| 2-ethylhexyl- | 20 | 20 | 10 | 0 | 30 |
| S-lactate | | | | | |
| antifoam | 0.01 | 0.01 | 0.01 | 0.01 | 0.01 |
| Nansa ® | 5 | 0 | 5 | 5 | 5 |
| EVM 63/B | | | | | |
| Toximul ® 8240 | 21.79 | 0 | 21.79 | 21.79 | 11.79 |
| Toximul ® 8320 | 0 | 5 | 0 | 0 | 0 |
| Tween ® 85 | 0 | 21.79 | 0 | 0 | 0 |
| RATING | C, B | B, B | C, B | B, C | B, D |

TABLE 2F

| | Ex. 35^{1,2} | Ex. 36^{1,2} | Ex. 37^{1,2} | Ex. 38^{1,2} | Ex. 39² | Ex. 40² | Ex. 41^{1,2} |
|---|---|---|---|---|---|---|---|
| Material | % w/w | % w/w | % w/w | % w/w | % w/w | % w/w | % w/w |
| Oxathiapiprolin | 3.30 | 3.30 | 3.30 | 3.30 | 3.30 | 3.30 | 3.30 |
| Mefenoxam | 9.90 | 9.90 | 9.90 | 9.90 | 9.90 | 9.90 | 9.90 |
| Acetophenone | 20.00 | 20.00 | 30.00 | 20.00 | 20.00 | 20.00 | 10.00 |
| Agnique ® AMD 3L | 20.00 | 20.00 | 30.00 | 30.00 | 25.00 | 30.00 | 30.00 |
| 2-ethylhexyl-S-lactate | 20 | 20 | 0 | 20 | 20 | 20 | 20 |
| Antifoam | 0.01 | 0.01 | 0.01 | 0.01 | 0.01 | 0.01 | 0.01 |
| Nansa ® EVM 63/B | 5 | 0 | 5 | 0 | 0 | 0 | 0 |
| Toximul ® 8240 | 0 | 21.79 | 21.79 | 0 | 0 | 11.79 | 0 |
| Toximul ® 8320 | 0 | 0 | 0 | 5 | 5 | 0 | 5 |
| Tween ® 85 | 0 | 0 | 0 | 11.79 | 16.79 | 0 | 21.79 |
| Bio-Soft ® N-300 | 0 | 5 | 0 | 0 | 0 | 0 | 0 |
| Tween ® 80 | 0 | 0 | 0 | 0 | 0 | 0 | 0 |
| Toximul ® 8241 | 21.79 | 0 | 0 | 0 | 0 | 0 | 0 |
| Rhodasurf ® BC-610 | 0 | 0 | 0 | 0 | 0 | 5 | 0 |
| RATING | B, B | B, B | B, C | C, C | D | D | B, B |

| | Ex. 43^{1,2} | Ex. 44^{1,2} | Ex. 45^{1,2} | Ex. 46^{1,2} | Ex. 47² |
|---|---|---|---|---|---|
| Material | % w/w | % w/w | % w/w | % w/w | % w/w |
| Oxathiapiprolin | 3.30 | 3.30 | 3.30 | 3.30 | 3.30 |
| Mefenoxam | 9.90 | 9.90 | 9.90 | 9.90 | 9.90 |
| Acetophenone | 15.00 | 20.00 | 15.00 | 15.00 | 15.00 |
| Agnique ® AMD 3L | 30.00 | 20.00 | 30.00 | 30.00 | 30.00 |
| 2-ethylhexyl-S-lactate | 15 | 20 | 15 | 15 | 15 |
| antifoam | 0.01 | 0.01 | 0.01 | 0.01 | 0.01 |
| Nansa ® EVM 63/B | 0 | 0 | 0 | 0 | 0 |
| Toximul ® 8240 | 0 | 21.79 | 21.79 | 21.79 | 0 |
| Toximul ® 8320 | 5 | 5 | 5 | 2.5 | 5 |
| Tween ® 85 | 21.79 | 0 | 0 | 0 | 0 |
| Bio-Soft ® N-300 | 0 | 0 | 0 | 2.5 | 0 |
| Tween ® 80 | 0 | 0 | 0 | 0 | 21.79 |
| Toximul ® 8241 | 0 | 0 | 0 | 0 | 0 |
| Rhodasurf ® BC-610 | 0 | 0 | 0 | 0 | 0 |
| RATING | A, B | B, B | B, B | B, C | C |

TABLE 2G

| | Ex. | Ex. | Ex. | Ex. | Ex. |
|---|---|---|---|---|---|
| | 48^{1, 2} | 49^{1, 2} | 50^{1, 2} | 51² | 52² |
| Material | % w/w | % w/w | % w/w | % w/w | % w/w |
| Oxathiapiprolin | 3.31 | 3.31 | 3.31 | 3.32 | 2.49 |
| Mefenoxam | 9.92 | 9.92 | 9.92 | 9.96 | 7.47 |
| Agnique ® | 49.00 | 49.00 | 49.00 | 49.22 | 36.92 |
| AMD 3L | | | | | |
| Rhodiasolv ® | 5 | 0 | 0 | 0 | 0 |
| Polarclean | | | | | |
| Acetophenone | 12.71 | 16.53 | 16.48 | 0 | 0 |
| 2-ethylhexyl- | 0 | 0 | 0 | 15 | 20 |
| S-lactate | | | | | |
| antifoam | 0.01 | 0.01 | 0.01 | 0.01 | 0.01 |
| Atlox ® | 8.26 | 9.44 | 0 | 5.9 | 8.85 |
| 4913 | | | | | |
| Tween ® | 5.9 | 5.9 | 16.57 | 10.87 | 16.18 |
| 85 | | | | | |
| Toximul ® | 5.9 | 5.9 | 4.72 | 4.72 | 7.08 |
| 8320 | | | | | |
| Stepwet ® | 0 | 0 | 0 | 1 | 1 |
| DF-95 | | | | | |
| RATING | A, C | B, C | A, C | B | D |

TABLE 2H

| | Ex. 53² | Ex. 54² | Ex. 55² | Ex. 56² |
|---|---|---|---|---|
| Material | % w/w | % w/w | % w/w | % w/w |
| Oxathiapiprolin | 2.48 | 3.30 | 3.30 | 3.30 |
| Mefenoxam | 7.42 | 9.90 | 9.90 | 9.90 |
| Acetophenone | 0.00 | 0.00 | 0.00 | 0.00 |
| Agnique ® | 0.00 | 20.00 | 20.00 | 20.00 |
| AMD 3L | | | | |
| Rhodiasolv ® | 53.62 | 0.00 | 0.00 | 0.00 |
| Polarclean | | | | |
| 2-ethylhexyl- | 15.00 | 20.00 | 20.00 | 20.00 |
| S-lactate | | | | |
| Hallcomid ® | 0.00 | 20.00 | 0.00 | 10.00 |
| M-8-10 | | | | |
| Butyl Lactate | 0.00 | 0.00 | 20.00 | 10.00 |
| Antifoam 1 | 0.00 | 0.01 | 0.01 | 0.01 |
| Toximul ® 8240 | 0.00 | 21.79 | 21.79 | 21.79 |
| Toximul ® 8320 | 4.71 | 5.00 | 5.00 | 5.00 |
| Tween ® 85 | 10.87 | 0.00 | 0.00 | 0.00 |
| Atlox ® 4913 | 5.90 | 0.00 | 0.00 | 0.00 |
| Antifoam 2 | 0.004 | 0.00 | 0.00 | 0.00 |
| RATING | D | C | C | C |

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

1. A composition, comprising:
oxathiapiprolin;
metalaxyl-M;
at least one component selected from a surfactant, an emulsifier, and a dispersing agent; and
a solvent system, comprising:
a water-soluble solvent,
a first partially water-soluble solvent, and
a second partially water-soluble solvent.

2. The composition according to claim 1, wherein the composition is a dispersible concentrate.

3. The composition according to claim 1, wherein the total amount of agrochemical present in the composition is 5 to 20% w/w.

4. The composition according to claim 3, wherein the total amount of solvent present in the composition is 40 to 80% w/w.

5. The composition according to claim 4, wherein:
the water-soluble solvent is a lactic acid derivative;
the first partially water-soluble solvent is an aromatic ketone; and
the second partially water-soluble solvent is a lactic acid derivative.

6. The composition according to claim 4, wherein:
the water-soluble solvent is N,N-dimethyl lactamide;
the first partially water-soluble solvent is acetophenone; and
the second partially water-soluble solvent is 2-ethylhexyl-S-lactate.

7. The composition according to claim 1, wherein
the ratio of water-soluble solvent to partially water-soluble solvent is 1:3 to 3:1.

8. A composition, comprising:
a first agrochemical;
a second agrochemical;
at least one component selected from a surfactant, an emulsifier, and a dispersing agent; and
a solvent system, that dissolves the first and second agrochemical, comprising:
a water-soluble solvent, and
a partially water-soluble solvent;
wherein the composition is a dispersible concentrate; and
wherein the first agrochemical is different from the second agrochemical.

9. The composition according to claim 8, wherein:
the total amount of agrochemical present in the composition is 5 to 20% w/w; and
the total amount of solvent present in the composition is 40 to 80% w/w.

10. The composition according to claim 9, further comprising:
5 to 25% w/w a second partially water-soluble solvent; and
wherein:
the water-soluble solvent is present at 10 to 40% w/w;
the partially water-soluble solvent is present in the composition at 5 to 25%; and
wherein the ratio of water-soluble solvent to partially water-soluble solvent is 1:3 to 3:1.

11. The composition according to claim 9, wherein the particulate size of the agrochemicals in the composition substantially remains below 300 microns after diluting in 100-20′000 times water.

12. The composition according to claim 11, wherein the composition is free of a dispersant or crystal growth inhibitor.

13. A composition, comprising:
a first agrochemical;
at least one component selected from a surfactant, an emulsifier, and a dispersing agent; and
a solvent system, that dissolves the first agrochemical, comprising:
a water-soluble solvent,
a first partially water-soluble solvent, and
a second partially water-soluble solvent;
wherein the composition is a dispersible concentrate; and
wherein said composition further optionally comprises a second agrochemical,
wherein the first agrochemical is different from the second agrochemical.

14. The composition according to claim 13, wherein:
the water-soluble solvent is a lactic acid derivative;
the first partially water-soluble solvent is an aromatic ketone; and
the second partially water-soluble solvent is a lactic acid derivative.

15. The composition according to claim 13, wherein:
the water-soluble solvent is N,N-dimethyl lactamide;
the first partially water-soluble solvent is acetophenone; and
the second partially water-soluble solvent is 2-ethylhexyl-S-lactate.
